(19) United States
(12) Patent Application Publication
(10) Pub. No.: US 2005/0105819 A1
(43) Pub. Date: May 19, 2005

(54) Quick blur approximation

(75) Inventors: Warren Burch, Redmond, WA (US); Eric Juteau, Woodinville, WA (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Microsoft Corporation

(21) Appl. No.: 10/713,525

(22) Filed: Nov. 13, 2003

(51) Int. Cl. G06K 9/40; H04N 9/74

(52) U.S. Cl. 382/264; 348/578

(57) ABSTRACT

A method and system of blurring a digital video image or video stream having a plurality of pixels, each having a value specifying color data. A particular pixel of the plurality of pixels is identified. A number of pixels from the plurality of pixels is selected. A blurred value is determined as a function of the values of the selected pixels. The value of the particular pixel is replaced with the blurred value.

### TECHNICAL FIELD

Embodiments of the present invention relate to the field of processing of digital video signals. In particular, embodiments of this invention relate to digital image and video effects processing for creating a motion blur effect.

### BACKGROUND OF THE INVENTION

Many image blur methods require expensive channel separation and/or a multi-level operations to achieve a blur. Furthermore, many different effects might be applied to each frame of a video. In order to accomplish such effects including blurring in real time or near real time, significant processing is required. In some systems, the bottleneck for processing a plurality of video effects may be blurring. For example, many blurring techniques employ a weighted convolution which must process several pixels of information on a color-by-color basis.

There is a need for a blurring effect which can be applied quickly to a 32 bit ARGB raster image buffer (or to a title overlaying on a video stream). There is also a need for developing a blurring effect which is not time expensive and does not require a convolution so that it can be applied many times to get the effect of dynamic blurring.

### SUMMARY OF THE INVENTION

The invention relates to digital imaging and video effects processing and introduces techniques for modifying pixels for creating and applying a motion blur effect at a very low cycle cost. The invention avoids the need for channel separation and convolution of the pixels and their color content. According to one embodiment of the invention, an approximation blur method and system applicable to a 32 bit ARGB buffer and to other video and images is used. According to an embodiment of the invention, significantly fewer operations per pixel are employed to create a blurring effect. The invention may be implemented in one line of code to calculate each new pixel having a blurring effect according to the invention. The technique of the invention makes efficient use of masking and shifting to divide all color channels of neighboring pixels simultaneously so that an approximate average can be calculated to create a blur effect that can be applied to every frame of a video stream or a video image within a fraction of the time of other types of blurring methods.

In one form, the invention includes a method of blurring a digital video image having a plurality of pixels, each having a value specifying color data. A particular pixel of the plurality of pixels is identified. P pixels from the plurality of pixels are selected. A blurred value is determined as a function of the values of the selected pixels. The value of the particular pixel is replaced with the blurred value.

In another form, the invention includes a system for blurring a digital video image having a plurality of pixels, each having a value specifying color data. A memory stores the values of the pixels of the digital video image. A processor identifies a particular pixel of the plurality of pixels, selects P pixels from the plurality of pixels, determines a blurred value as a function of the values of the selected pixels stored in the memory and replaces the value of the particular pixel stored in memory with the blurred value. A display displays the replaced values stored in memory and displays the other values stored in memory which have not been replaced.

In another form, the invention includes a computer readable medium having instructions for blurring a digital video image having a plurality of pixels, each having a value specifying color data. The instructions comprise:
Identifying a particular pixel of the plurality of pixels;
Selecting 2^{N} pixels from the plurality of pixels, where N is a positive integer;
Determining a blurred value as a function of the values of the selected pixels; and
Replacing the value of the particular pixel with the blurred value.

In another form, the invention includes a method of modifying values from a plurality of values. The method comprises identifying a particular value; selecting 2^{N} values from the plurality of values, where N is a positive integer; determining a modified value as a function of the selected values; and replacing the particular value with the modified value.

In another form, the invention includes a method of blurring a digital video image having a plurality of pixels, each having a value specifying color data. The method comprises:
Identifying a particular pixel of the plurality of pixels;
Selecting 2^{N} pixels from the plurality of pixels,
where N is a positive integer;
masking the least significant N bits of the value of each selected pixel to get a modified value for each selected pixel
dividing the modified value of each selected pixel by 2^{N} to get a divided value for each selected pixel;
summing the divided values to get a total value; and
replacing the value of the particular pixel with the total value whereby the particular pixel has a blurred value.

In another form, the invention includes a method of blurring a digital video image having a plurality of pixels, each having a value specifying color data. The method comprises identifying a particular pixel of the plurality of pixels; selecting 2^{N} pixels from the plurality of pixels, where N is a positive integer; right shifting by N bits the bits of the value of each selected pixel to get a modified value of each selected pixel; dividing the by 2^{N} to get a divided value for each selected pixel; summing the divided values to get a total value; and replacing the value of the particular pixel with the total value whereby the particular pixel has a blurred value.

Alternatively, the invention may comprise various other methods and apparatuses.

Other features will be in part apparent and in part pointed out hereinafter.

### BRIEF DESCRIPTION OF THE DRAWINGS

FIG. 1 is a diagram of nine pixels in a 3×3 array illustrating one exemplary embodiment of the invention in which a particular pixel value is provided a blurred value which is derived from two pixels contiguously positioned to the left and to the right of the particular pixel (i.e., a side blur).

FIG. 2 is an exemplary flow chart illustrating the operation of one embodiment of the invention.

FIGS. 3 and 4 are diagrams of nine pixels in a 3×3 array illustrating one exemplary embodiment of the invention in which a particular pixel value is provided a blurred value which is derived from two pixels contiguously positioned to the left and to the right of the particular pixel (i.e., a side blur).

FIG. 5 is a diagram of nine pixels in a 3×3 array illustrating one exemplary embodiment of the invention in which a particular pixel value is provided a blurred value which is derived from four pixels contiguously positioned to the top, bottom, left and right of the particular pixel.

FIG. 6 is a diagram of nine pixels in a 3×3 array illustrating one exemplary embodiment of the invention in which a particular pixel value is provided a blurred value which is derived from eight pixels contiguously positioned to the corners, top, bottom, left and right of the particular pixel.

FIG. 7 illustrates a video image before a blur according to the invention is applied.

FIG. 8 illustrates the image of FIG. 7 after a two pixel (side) blur has been applied to the image.

FIG. 9 illustrates a video image before a blur according to the invention is applied.

FIG. 10 illustrates the image of FIG. 9 after a four pixel blur has been applied to the image.

FIG. 11 illustrates a video image before a blur according to the invention is applied.

FIG. 12 illustrates the image of FIG. 11 after an eight pixel blur has been applied to the image.

FIG. 13 is a block diagram illustrating one example of a suitable computing system environment in which the invention may be implemented.

Corresponding reference characters indicate corresponding parts throughout the drawings.

### DETAILED DESCRIPTION OF THE INVENTION

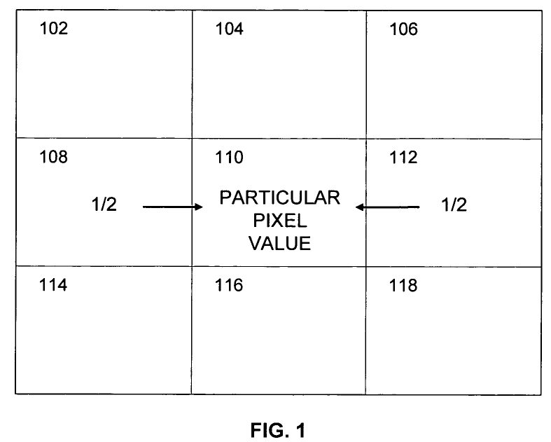

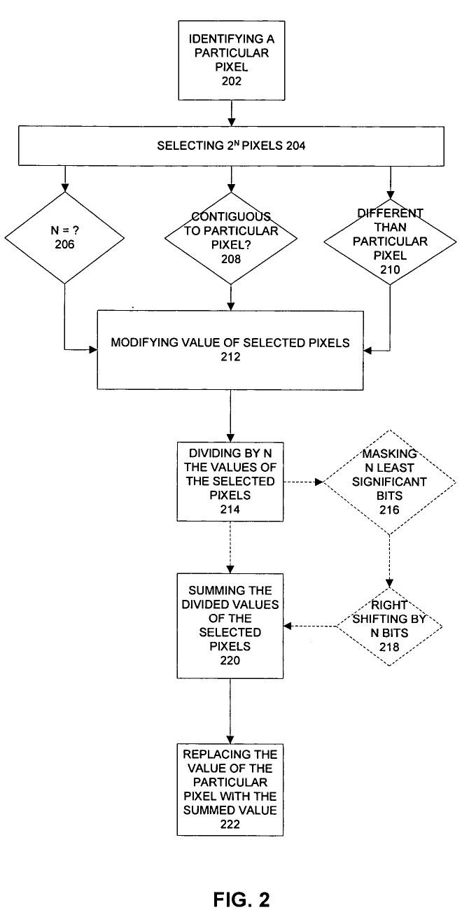

Referring to FIGS. 1 and 2, a method of blurring a digital video image 100 having a plurality of nine pixels 102, 104, 106, 108, 110, 112, 114, 116 and 118 in a 3×3 array is illustrated. In general, the invention is applicable to any or all pixels of a digital image or of video signal such as streaming video. The following is a description of the method and system of the invention as applied to a 3×3 array of nine pixels. In fact, the invention may be applied to selected pixels or to every pixel.

Each pixel has a value specifying color data. In one embodiment of the invention, the color data is a 32 bit pixel including color data in separate eight bit channels specifying A, R, G and B. In one embodiment of the invention, the color data does not have to be separately broken down into separate channels.

The following refers to FIGS. 1 and 2. Initially a particular pixel, such as interior pixel 110 is identified at 202 as a pixel whose value needs to be modified in order to create a blurring effect. As illustrated in FIG. 1, pixel 110 is one of a plurality of pixels. In order to create a blur of particular pixel 110, it's value will be modified based on other pixels within the image and, in this case, based on the other pixels which are contiguous to the particular pixel, as illustrated in FIG. 1. In the embodiment illustrated in FIG. 1, two contiguous side pixels 108 and 112 different from the particular pixel 110 are selected. In general, any number P of pixels may be selected. In one embodiment, P=2^{N} pixels, where N is an integer, may be selected as indicated by 204 of FIG. 2. Three decisions must be made in selecting the pixels. First, at 206 the number of pixels that will be employed to create the blurring effect must be determined. In one embodiment, the value of N may be an integer such as 1, 2 or 3. In other embodiments the value of N may be a greater integer than 3. In addition, a decision must be made at 208 as to whether or not the selected pixels should be contiguous to the particular pixel 110. A decision must also be made at 210 as to whether the selected pixels are different than the particular pixel at 210. The blurring effect may or may not take into account the value of the particular pixel. In the embodiment of FIG. 2, N equals 1 or 2 contiguous side pixels are selected which are different than the particular pixel 110.

At 212, the processing proceeds with the modification of the value of the selected pixels. In one embodiment of the invention, the pixel values are modified by dividing by N at 214 the values of the selected pixels 214. Those skilled in the art will recognize various ways for achieving such dividing. In one embodiment, the invention comprises ignoring or masking N least significant bits at 216 followed by right shifting by N bits the value of each selected pixel at 218. For the example of FIG. 1 where N equals 1, the value of pixels 108 and 112 is modified by ignoring the least significant bit and by right shifting by one bit. This essentially has the effect of dividing by 2 the value of the each of the pixels 108 and 112. For example, 255 written as binary value is 11111111. Ignoring the least significant bit and right shifting results in a binary value of 01111111 which is 128, or the value approximately divided by 2.

At 220 the divided values of the selected pixels are then summed and at 222 the summed or total value is substituted for the value of the particular pixel 110 to create the blurring effect of the invention.

As another example, the particular pixel value may be used in the process of generating the blurred pixel value. For example, as shown in FIG. 1 the value of pixels 108, 110 and 112 could each be divided by one-third and added to determine the blurred pixel value which would be substituted for the center pixel 110. However, this would not be viewed as a fast implementation as the shift operation (for dividing) would not be in a convenient form for further processing.

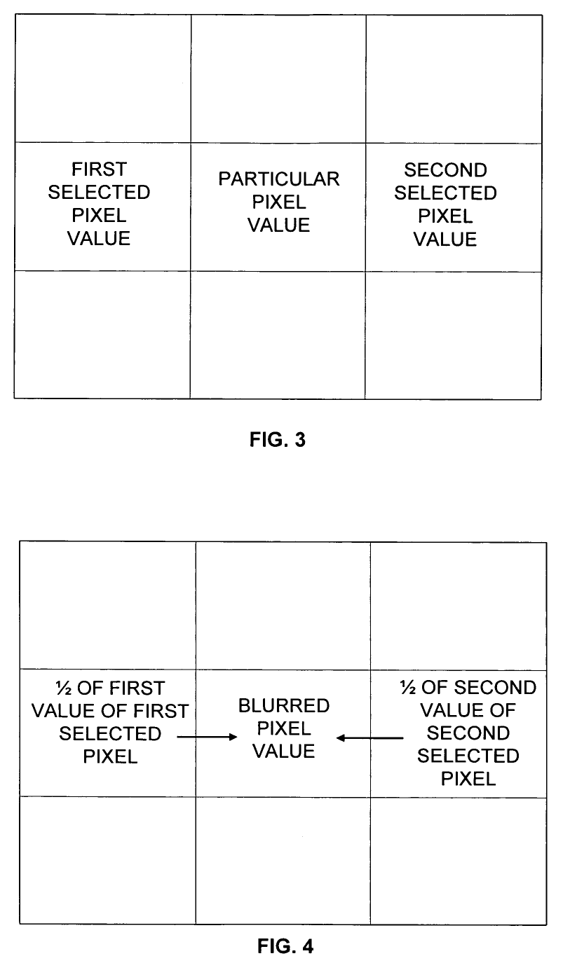

FIGS. 3 and 4 taken in sequence illustrate the embodiment of the invention described above with respect to FIGS. 1 and 2 wherein two pixels, a left pixel and a right pixel are used to generate a value for a particular center pixel. This is sometimes referred to a side blur since the pixels that are being used to generate the value for the particular pixel are on either side of the particular pixel. As shown in FIG. 3, the values of the left and right pixels are selected as the first selected pixel and the second selected pixel, respectively. As noted above, the pixels need not be contiguous to the particular pixel, which in this case is the center pixel. In addition, the center pixel may be one of the pixels selected. As shown in FIG. 4, half of the first value of the first selected pixel is determined and half of the second value of the second selected pixel is determined. These values are added and substituted for the value of the particular pixel in order to generate a blurred pixel value for the particular pixel. The arrows in FIG. 3 illustrate that half the value of each of the side pixels is being substituted for the value of the particular pixel to result in the blurred pixel value.

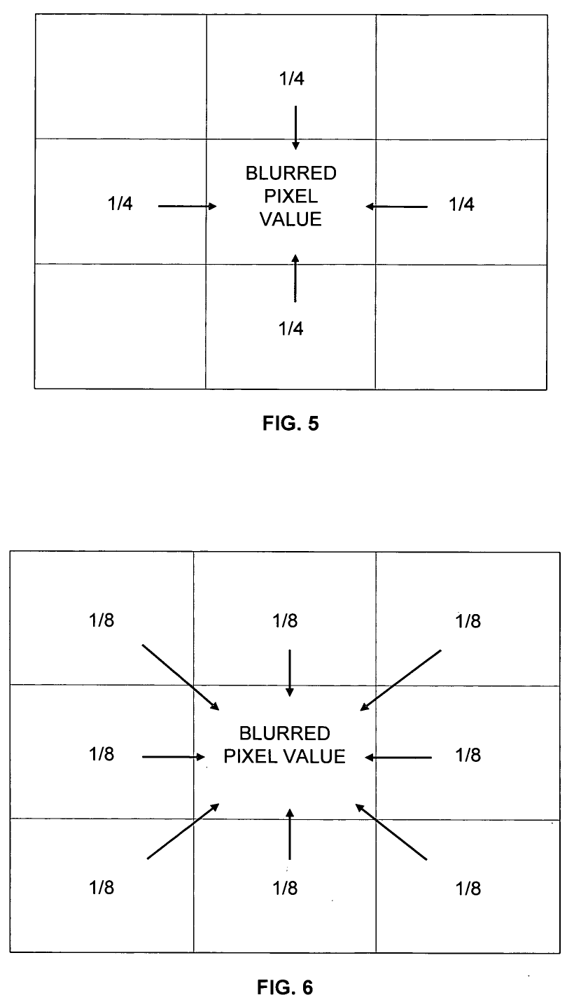

FIG. 5 illustrates another embodiment of the invention in which four pixels are used to generate a blurred pixel value for the particular pixel (e.g., the center pixel). As illustrated in FIG. 5, the left, right, top and bottom contiguous pixels are selected. A quarter of the value of each selected pixel is determined and the determined values are added together to substitute for the particular center pixel. This results in a blurred pixel value for the center pixel. Similarly, FIG. 6 illustrates an embodiment in which eight contiguous pixels are used to contribute to the blurred pixel value. In FIG. 6, one-eighth of the value of each of the contiguous pixels of the center pixel is determined and the determined values are added to result in a total value which is substituted for the particular pixel value. As another example, the particular pixel may also contribute to the blurred pixel value. For example, in FIG. 5, the left, right, top, bottom and center pixels are selected. A fifth of the value of each selected pixel is determined and the determined values are added together to substitute for the particular center pixel. This results in a blurred pixel value for the center pixel. Similarly, FIG. 6 illustrates an embodiment in which all nine pixels are used to contribute to the blurred pixel value. In FIG. 6, one-ninth of the value of each of the pixels is determined and the determined values are added to result in a total value which is substituted for the particular pixel value.

As noted above, the pixels do not have to be contiguous. In one embodiment, the position relationship between the selected pixels and the particular pixel would be the same for each pixel which is blurred. For example, if the selected pixels were two pixels above and below the particular pixel, for each particular pixel in an image or portion thereof, the second from the top and second from the bottom pixels would be used to generate the value for the particular pixel to create the blur. Those skilled in the art will recognize other pixels which may be selected to generate the blurred pixel value and that not every pixel needs to have a blurred value.

In one embodiment, the process of substituting blurred values is applied to each and every pixel of an image. Thus, as noted above, the value of particular pixel 110 is modified. For each additional pixel (e.g., pixels 102, 104, 106, 108, 112, 114, 116 and 118 of FIG. 1; not particular pixel 110), the method of the invention includes identifying another pixel (e.g., 104) of the plurality of pixels other than the particular pixel (110) as an additional particular pixel. For the additional particular pixel (104), selecting 2^{M} additional pixels from the plurality of pixels, where M is a positive integer (e.g., for M=2 and a side blur, selecting 102 and 106), determining an additional blurred value as a function of the values of the selected additional pixels (half of value of 102 plus half of value of 106); and replacing the value of the additional particular pixel 104 with the additional blurred value. This process is applied to each additional pixel.

As noted above with regard to one embodiment, the particular pixel would be identified and 2^{N} pixels from the pixels surrounding the particular pixel would be selected, where N is a positive integer. In one embodiment N equals 1, 2 or 3. One advantage of this embodiment is that the entire operation may be accomplished by a small number of fast machine operations (sometimes referred to as “a single line of computer code”). The pixels are averaged without having to separate each channel component This is because, as noted above, in binary the values of the pixels can easily be divided by two, four or eight simply by ignoring (masking) one or more of the least significant bits and by right shifting the binary value. For example, an eight bit binary value for one of the components of the color data of a particular pixel can be divided by ignoring the three least significant bits and by right shifting to the right three places.

In general, in one embodiment, all channels on a pixel effectively get handled in parallel. As an example, for the side blur noted above with regard to FIGS. 1-4, the left and right values are averaged by ignoring the last least significant bit (LSB) of each channel and using a right-shift by 1 to divide (5 operations per pixel):
NewValueOfCurrentPixel=(PixelOnTheLeft & 0xFEFEFEFE)>>1+(PixelonTheRight & 0xFEFEFEFE)>>1
   Furthermore, the same method may be used to average the 4 neighborhood pixels (Top, Bottom, Left, Right; FIG. 5), by ignoring the last 2 LSBs and averaging them (right-shifting by 2 is equivalent to diving them by 4) which would provide 4 direction blur effect (11 operations per pixel):
NewValueOfCurrentPixel=(PixelOnTheLeft & 0xFCFCFCFC)>>2+(PixelOnTheRight & 0xFCFCFCFC)>>2+(PixelOnTheTop & 0xFCFCFCFC)>>2+(PixelOnTheBottom & 0xFCFCFCFC)>>2

Finally, the same method may applied on all 8 surrounding pixels (FIG. 6), by ignoring their last 3 LSBs, and averaging them (right-shifting them by 3 is equivalent to dividing them by 8) to obtain a blur approximation (23 operations per pixel):
NewValueOfCurrentPixel=(PixelOnTheLeft&0xF8F8F8F8)>>3+(PixelOnTheRight&0xF8F8F8F8)>>3+(PixelOnTheTopLeft&0xF8F8F8F8)>>3+(PixelOnTheTop&0xF8F8F8F8)>>3+(PixelOnTheTopRight&0xF8F8F8F8)>>3+(PixelOnTheBottomLeft&0xF8F8F8F8)>3+(PixelOnTheBottom&0xF8F8F8F8)>>3+(PixelOnTheBottomRight&0xF8F8F8F8)>>3

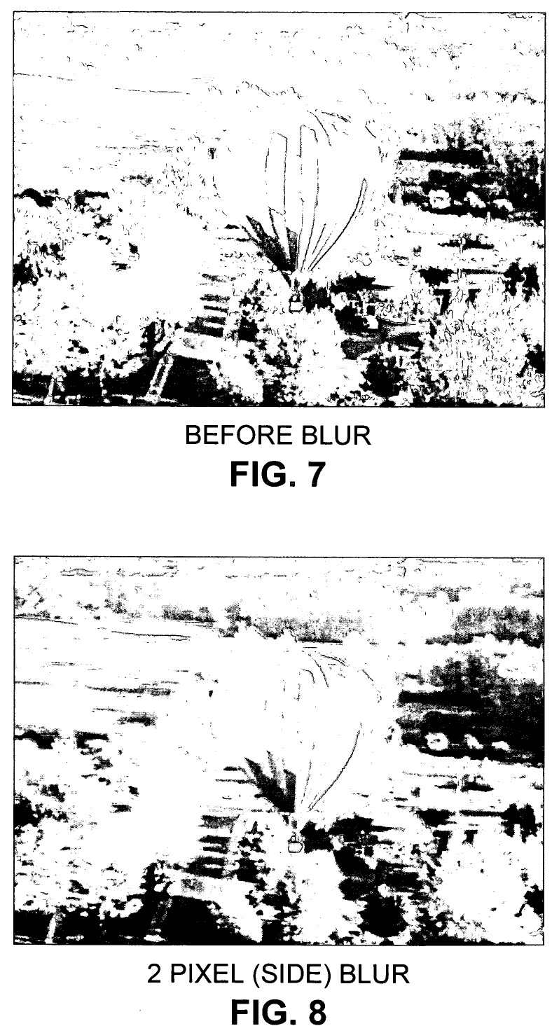

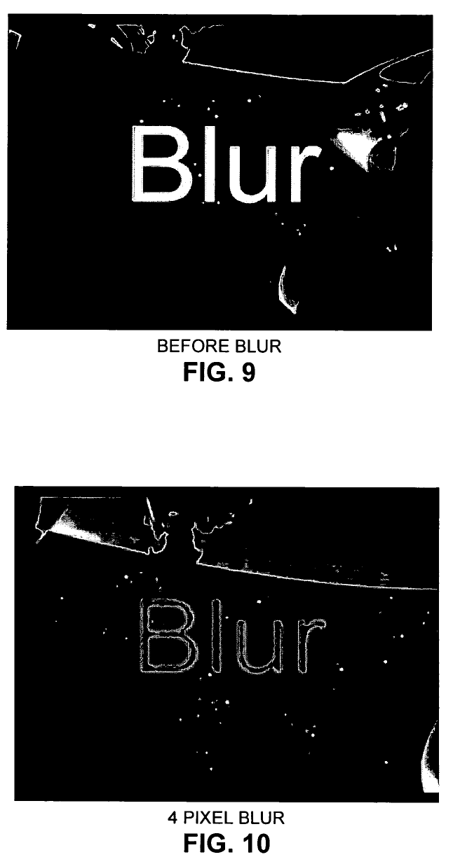

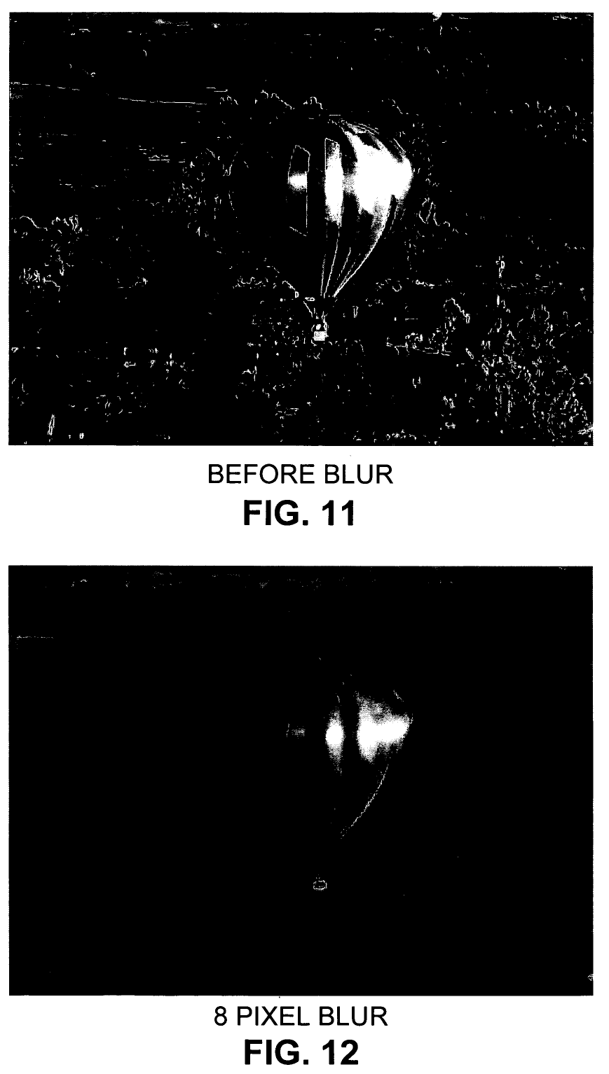

FIG. 8 illustrates a two pixel or a side blur according to FIGS. 1-3 of the image of FIG. 7. FIG. 10 illustrates a four pixel blur according to FIG. 4 of the picture of FIG. 9. FIG. 12 illustrates an eight pixel blur according to FIG. 5 of the image of FIG. 11.

There are many different reasons for employing the blur according to the invention. For example, titling is an aspect which can be enhanced by blurring.

In one embodiment of the invention blurring may be used to implement an age filter, as illustrated by the following computer code:

```
HRESULT CAge::Blur(DXPMSAMPLE *pargb)
{
  for (int iPass=0;iPass<m_dBlur;iPass++)
  {
    UINT* pixels = (UINT*)(pargb+m_cxImage);
    for (int y = 1 ; y < (int)m_cyImage−1; y++)
    {
      pixels++;
      for (int x = 1 ; x < (int)m_cxImage−1; x++, pixels++)
      {
        *pixels=((*(pixels−1) & 0×FCFCFCFC) >> 2) +
              ((*(pixels+1) & 0×FCFCFCFC) >> 2) +
              ((*(pixels+m_cxImage*1) & 0×FCFCFCFC) >> 2) +
              ((*(pixels−m_cxImage*1) & 0×FCFCFCFC) >> 2);
      }
      pixels++;
    }
  }
  return S_OK;
}
```

As noted above, the invention in one embodiment is an algorithm that operates on image buffers that represent each pixel as a thirty-two bit value and that have distinct information channels of eight bits each (i.e., an ARGB image buffer). Other common image buffer formats which follow this format and for which the invention is applicable include RGB 32, and ARGB 32. Those skilled in the art will recognize other similar or related formats to which the invention may be applied.

By applying the quick blur filter on a video stream or an image, a de-focused effect can be accomplished softening the image and/or the video. Horizontal blurring effects can be accomplished by averaging only the left or right pixel. Vertical blurring effects can be accomplished by averaging only the top and bottom pixels. This provides a horizontal or vertical softening effect which can be pleasing to the eye. Blurring can also be used to effect transitions. By applying the invention repeatedly to the same image, or by blurring a blur filter multiple times using a ramp (e.g., blurring the first frame of a transition once, blurring the second frame of a transition twice and, etc.), an interesting video transition where video would blur away can be accomplished. Titling blurred shadows is also one embodiment of the invention. Shadows using titling are usually blurred to provide the illusion of shadowing. The invention can be used on titling to accomplish a similar look.

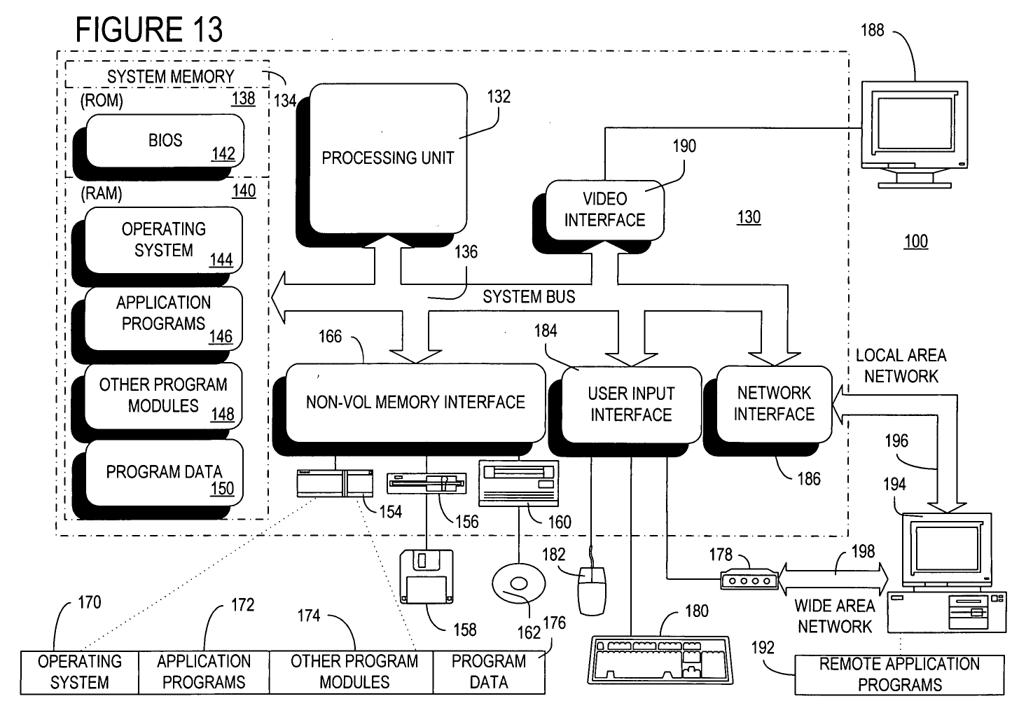

FIG. 13 illustrates an operating environment which may be used to execute the invention. In operation, computer 130 executes computer-executable instructions such as those illustrated in FIG. 2 to blur an image or video stream. FIG. 13 shows one example of a general purpose computing device in the form of a computer 130. In one embodiment of the invention, a computer such as the computer 130 is suitable for use in the other figures illustrated and described herein. Computer 130 has one or more processors or processing units 132 and a system memory 134. In the illustrated embodiment, a system bus 136 couples various system components including the system memory 134 to the processors 132. The bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 130 typically has at least some form of computer readable media. Computer readable media, which include both volatile and nonvolatile media, removable and non-removable media, may be any available medium that can be accessed by computer 130. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computer 130. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of the any of the above are also included within the scope of computer readable media.

The system memory 134 includes computer storage media in the form of removable and/or non-removable, volatile and/or nonvolatile memory. In the illustrated embodiment, system memory 134 includes read only memory (ROM) 138 and random access memory (RAM) 140. A basic input/output system 142 (BIOS), containing the basic routines that help to transfer information between elements within computer 130, such as during start-up, is typically stored in ROM 138. RAM 140 typically contains data and/or program modules that are immediately accessible to and/or presently being operated on by processing unit 132. By way of example, and not limitation, FIG. 13 illustrates operating system 144, application programs 146, other program modules 148, and program data 150.

The computer 130 may also include other removable/non-removable, volatile/nonvolatile computer storage media. For example, FIG. 13 illustrates a hard disk drive 154 that reads from or writes to non-removable, nonvolatile magnetic media. FIG. 13 also shows a magnetic disk drive 156 that reads from or writes to a removable, nonvolatile magnetic disk 158, and an optical disk drive 160 that reads from or writes to a removable, nonvolatile optical disk 162 such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 154, and magnetic disk drive 156 and optical disk drive 160 are typically connected to the system bus 136 by a non-volatile memory interface, such as interface 166.

The drives or other mass storage devices and their associated computer storage media discussed above and illustrated in FIG. 13, provide storage of computer readable instructions, data structures, program modules and other data for the computer 130. In FIG. 13, for example, hard disk drive 154 is illustrated as storing operating system 170, application programs 172, other program modules 174, and program data 176. Note that these components can either be the same as or different from operating system 144, application programs 146, other program modules 148, and program data 150. Operating system 170, application programs 172, other program modules 174, and program data 176 are given different numbers here to illustrate that, at a minimum, they are different copies.

A user may enter commands and information into computer 130 through input devices or user interface selection devices such as a keyboard 180 and a pointing device 182 (e.g., a mouse, trackball, pen, or touch pad). Other input devices (not shown) may include a microphone, joystick, game pad, satellite dish, scanner, or the like. These and other input devices are connected to processing unit 132 through a user input interface 184 that is coupled to system bus 136, but may be connected by other interface and bus structures, such as a parallel port, game port, or a Universal Serial Bus (USB). A monitor 188 or other type of display device is also connected to system bus 136 via an interface, such as a video interface 190. In addition to the monitor 188, computers often include other peripheral output devices (not shown) such as a printer and speakers, which may be connected through an output peripheral interface (not shown).

The computer 130 may operate in a networked environment using logical connections to one or more remote computers, such as a remote computer 194. The remote computer 194 may be a personal computer, a server, a router, a network PC, a peer device or other common network node, and typically includes many or all of the elements described above relative to computer 130. The logical connections depicted in FIG. 13 include a local area network (LAN) 196 and a wide area network (WAN) 198, but may also include other networks. LAN 136 and/or WAN 138 can be a wired network, a wireless network, a combination thereof, and so on. Such networking environments are commonplace in offices, enterprise-wide computer networks, intranets, and global computer networks (e.g., the Internet).

When used in a local area networking environment, computer 130 is connected to the LAN 196 through a network interface or adapter 186. When used in a wide area networking environment, computer 130 typically includes a modem 178 or other means for establishing communications over the WAN 198, such as the Internet. The modem 178, which may be internal or external, is connected to system bus 136 via the user input interface 184, or other appropriate mechanism. In a networked environment, program modules depicted relative to computer 130, or portions thereof, may be stored in a remote memory storage device (not shown). By way of example, and not limitation, FIG. 13 illustrates remote application programs 192 as residing on the memory device. It will be appreciated that the network connections shown are exemplary and other means of establishing a communications link between the computers may be used.

Generally, the data processors of computer 130 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The invention described herein includes these and other various types of computer-readable storage media when such media contain instructions or programs for implementing the steps described below in conjunction with a microprocessor or other data processor. The invention also includes the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including computer 130, the invention is operational with numerous other general purpose or special purpose computing system environments or configurations. The computing system environment is not intended to suggest any limitation as to the scope of use or functionality of the invention. Moreover, the computing system environment should not be interpreted as having any dependency or requirement relating to any one or combination of components illustrated in the exemplary operating environment. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

The invention may be described in the general context of computer-executable instructions, such as program modules, executed by one or more computers or other devices. Generally, program modules include, but are not limited to, routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Those skilled in the art will note that the order of execution or performance of the methods illustrated and described herein is not essential, unless otherwise specified. That is, elements of the methods may be performed in any order, unless otherwise specified, and that the methods may include more or less elements than those disclosed herein.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above products and methods without departing from the scope of the invention, it is intended that all matter contained in the above description and shown in the accompanying drawings shall be interpreted as illustrative and not in a limiting sense.

1. A method of blurring a digital video image having a plurality of pixels, each having a value specifying color data, said method comprising:
Identifying a particular pixel of the plurality of pixels;
Selecting P pixels from the plurality of pixels;
Determining a blurred value as a function of the values of the selected pixels; and
Replacing the value of the particular pixel with the blurred value.

2. The method of claim 1 wherein P=2^{N}, N=1, 2 or 3 and wherein the selected pixels are different from and contiguous to the particular pixel.

3. The method of claim 1 wherein P=2^{N} and further comprising identifying another pixel of the plurality of pixels other than the particular pixel as an additional particular pixel, and for said additional particular pixel:
Selecting 2^{M} additional pixels from the plurality of pixels, where M is a positive integer;
Determining an additional blurred value as a function of the values of the selected additional pixels; and
Replacing the value of the additional particular pixel with the additional blurred value.

4. The method of claim 3 wherein P=2^{N} and wherein N=1, 2 or 3 and wherein the selected pixels are different from and contiguous to the particular pixel and to the additional particular pixel.

5. The method of claim 1 wherein P=2^{N} and further comprising identifying each of the plurality of pixels other than the particular pixel as an additional particular pixel, and for each said additional particular pixel:
Selecting 2^{M} additional pixels from the plurality of pixels, where M is a positive integer;
Determining an additional blurred value as a function of the values of the selected additional pixels; and
Replacing the value of the additional particular pixel with the additional blurred value.

6. The method of claim 5 wherein P=2^{N} and wherein N=1, 2 or 3 and wherein the selected pixels are different from and contiguous to the particular pixel and to the additional particular pixels.

7. The method of claim 1 wherein P=2^{N} and wherein determining comprises calculating an average of the values of the selected pixels and wherein replacing comprises replacing the value of the particular pixel with the average.

8. The method of claim 7 wherein N=1, wherein determining comprises masking the least significant bit of the value of each selected pixel, dividing the masked value of each selected pixel by 2 to get a divided value for each selected pixel, and summing the divided values to get a total value, and wherein replacing comprising replacing the value of the particular pixel with the total value.

9. The method of claim 8 wherein dividing comprising right shifting by one bit the bits of the value of each selected pixel.

10. The method of claim 7 wherein N=2, wherein determining comprises masking the least significant bit and masking the second least significant bit of the value of each selected pixel, dividing the masked value of each selected pixel by 4 to get a divided value for each selected pixel, and summing the divided values to get a total value, and wherein replacing comprising replacing the value of the particular pixel with the total value.

11. The method of claim 10 wherein dividing comprising right shifting by two bits the bits of the value of each selected pixel.

12. The method of claim 7 wherein N=3, wherein determining comprises masking the least significant bit, masking the second least significant bit and masking the third least significant bit of the value of each selected pixel, dividing the masked value of each selected pixel by 8 to get a divided value for each selected pixel, and summing the divided values to get a total value, and wherein replacing comprising replacing the value of the particular pixel with the total value.

13. The method of claim 12 wherein dividing comprising right shifting by three bits the bits of the value of each selected pixel.

14. The method of claim 1 wherein P=2^{N} and wherein the determining and replacing is accomplished by processing all channels of the selected pixel in parallel.

15. A system for blurring a digital video image having a plurality of pixels, each having a value specifying color data, said system comprising:
A memory storing the values of the pixels of the digital video image; and
A processor for:
Identifying a particular pixel of the plurality of pixels;
Selecting P pixels from the plurality of pixels;
Determining a blurred value as a function of the values of the selected pixels stored in the memory; and
Replacing the value of the particular pixel stored in memory with the blurred value;
A display for displaying the replaced values stored in memory and displaying the other values stored in memory which have not been replaced.

16. The system of claim 15 wherein P=2^{N}, N=1, 2 or 3 and wherein the selected pixels are different from and contiguous to the particular pixel.

17. The system of claim 15 wherein P=2^{N}, said processor identifying another pixel of the plurality of pixels other than the particular pixel as an additional particular pixel, and for said additional particular pixel:
Selecting 2^{M} additional pixels from the plurality of pixels, where M is a positive integer;
Determining an additional blurred value as a function of the values of the selected additional pixels; and
Replacing the value of the additional particular pixel with the additional blurred value.

18. The system of claim 15 wherein P=2^{N}, said processor identifying each of the plurality of pixels other than the particular pixel as an additional particular pixel, and for each said additional particular pixel:
Selecting 2^{M} additional pixels from the plurality of pixels, where M is a positive integer;
Determining an additional blurred value as a function of the values of the selected additional pixels; and
Replacing the value of the additional particular pixel with the additional blurred value.

19. The system of claim 15 wherein P=2^{N} and wherein determining comprises calculating an average of the values of the selected pixels and wherein replacing comprises replacing the value of the particular pixel with the average.

20. The system of claim 15 wherein P=2^{N} and wherein the determining and replacing is accomplished by processing all channels of the selected pixel in parallel.

21. A computer readable medium having instructions for blurring a digital video image having a plurality of pixels, each having a value specifying color data, said instructions comprising:
Identifying a particular pixel of the plurality of pixels; Selecting 2^{N} pixels from the plurality of pixels, where N is a positive integer;
Determining a blurred value as a function of the values of the selected pixels; and
Replacing the value of the particular pixel with the blurred value.

22. The medium of claim 21 wherein P=2^{N}, N=1, 2 or 3 and wherein the selected pixels are different from and contiguous to the particular pixel.

23. The medium of claim 21 wherein P=2^{N}, said instructions further comprising identifying another pixel of the plurality of pixels other than the particular pixel as an additional particular pixel, and for said additional particular pixel:
Selecting 2^{M} additional pixels from the plurality of pixels, where M is a positive integer;
Determining an additional blurred value as a function of the values of the selected additional pixels; and
Replacing the value of the additional particular pixel with the additional blurred value.

24. The medium of claim 21 wherein P=2^{N}, said instructions further comprising identifying each of the plurality of pixels other than the particular pixel as an additional particular pixel, and for each said additional particular pixel:
Selecting 2^{M} additional pixels from the plurality of pixels, where M is a positive integer;
Determining an additional blurred value as a function of the values of the selected additional pixels; and
Replacing the value of the additional particular pixel with the additional blurred value.

25. The medium of claim 21 wherein P=2^{N} and wherein determining comprises calculating an average of the values of the selected pixels and wherein replacing comprises replacing the value of the particular pixel with the average.

26. The medium of claim 21 wherein P=2^{N} and wherein the determining and replacing is accomplished by processing all channels of the selected pixel in parallel.

27. A method of modifying values from a plurality of values, said method comprising:
Identifying a particular value;
Selecting 2^{N} values from the plurality of values, where N is a positive integer;
Determining a modified value as a function of the selected values; and
Replacing the particular value with the modified value.

28. The method of claim 27 wherein P=2^{N}, N=1, 2 or 3 and wherein the selected pixels are different from and contiguous to the particular pixel.

29. The method of claim 27 wherein P=2^{N} and further comprising identifying another pixel of the plurality of pixels other than the particular pixel as an additional particular pixel, and for said additional particular pixel:
Selecting 2^{M} additional pixels from the plurality of pixels, where M is a positive integer;
Determining an additional blurred value as a function of the values of the selected additional pixels; and
Replacing the value of the additional particular pixel with the additional blurred value.

30. The method of claim 27 wherein P=2^{N} and further comprising identifying each of the plurality of pixels other than the particular pixel as an additional particular pixel, and for each said additional particular pixel:
Selecting 2^{M} additional pixels from the plurality of pixels, where M is a positive integer;
Determining an additional blurred value as a function of the values of the selected additional pixels; and
Replacing the value of the additional particular pixel with the additional blurred value.

31. The method of claim 27 wherein P=2^{N} and wherein determining comprises calculating an average of the values of the selected pixels and wherein replacing comprises replacing the value of the particular pixel with the average.

32. The method of claim 27 wherein P=2^{N} and wherein the determining and replacing is accomplished by processing all channels of the selected pixel in parallel.

33. A method of blurring a digital video image having a plurality of pixels, each having a value specifying color data, said method comprising:
Identifying a particular pixel of the plurality of pixels;
Selecting 2^{N} pixels from the plurality of pixels, where N is a positive integer;
masking the least significant N bits of the value of each selected pixel to get a modified value for each selected pixel
dividing the modified value of each selected pixel by 2^{N} to get a divided value for each selected pixel;
summing the divided values to get a total value; and
replacing the value of the particular pixel with the total value whereby the particular pixel has a blurred value.

34. The method of claim 33 wherein P=2^{N}, N=1, 2 or 3 and wherein the selected pixels are different from and contiguous to the particular pixel.

35. The method of claim 33 wherein P=2^{N} and further comprising identifying another pixel of the plurality of pixels other than the particular pixel as an additional particular pixel, and for said additional particular pixel:
Selecting 2^{M} additional pixels from the plurality of pixels, where M is a positive integer;
Determining an additional blurred value as a function of the values of the selected additional pixels; and
Replacing the value of the additional particular pixel with the additional blurred value.

36. The method of claim 33 wherein P=2^{N} and further comprising identifying each of the plurality of pixels other than the particular pixel as an additional particular pixel, and for each said additional particular pixel:
Selecting 2^{M} additional pixels from the plurality of pixels, where M is a positive integer;
Determining an additional blurred value as a function of the values of the selected additional pixels; and
Replacing the value of the additional particular pixel with the additional blurred value.

37. The method of claim 33 wherein P=2^{N} and wherein determining comprises calculating an average of the values of the selected pixels and wherein replacing comprises replacing the value of the particular pixel with the average.

38. The method of claim 33 wherein P=2^{N} and wherein the determining and replacing is accomplished by processing all channels of the selected pixel in parallel.

39. A method of blurring a digital video image having a plurality of pixels, each having a value specifying color data, said method comprising:
Identifying a particular pixel of the plurality of pixels;
Selecting 2^{N} pixels from the plurality of pixels, where N is a positive integer;
masking the least significant N bits of the value of each selected pixel to get a modified value of each selected pixel;
dividing the modified value by 2^{N} to get a divided value for each selected pixel;
summing the divided values to get a total value; and
replacing the value of the particular pixel with the total value whereby the particular pixel has a blurred value.

40. The method of claim 39 wherein P=2^{N}, N=1, 2 or 3 and wherein the selected pixels are different from and contiguous to the particular pixel.

41. The method of claim 39 wherein P=2^{N} and further comprising identifying another pixel of the plurality of pixels other than the particular pixel as an additional particular pixel, and for said additional particular pixel:
Selecting 2^{M} additional pixels from the plurality of pixels, where M is a positive integer;
Determining an additional blurred value as a function of the values of the selected additional pixels; and
Replacing the value of the additional particular pixel with the additional blurred value.

42. The method of claim 39 wherein P=2^{N} and further comprising identifying each of the plurality of pixels other than the particular pixel as an additional particular pixel, and for each said additional particular pixel:
Selecting 2^{M} additional pixels from the plurality of pixels, where M is a positive integer;
Determining an additional blurred value as a function of the values of the selected additional pixels; and
Replacing the value of the additional particular pixel with the additional blurred value.

43. The method of claim 39 wherein P=2^{N} and wherein determining comprises calculating an average of the values of the selected pixels and wherein replacing comprises replacing the value of the particular pixel with the average.

44. The method of claim 39 wherein P=2^{N} and wherein the determining and replacing is accomplished by processing all channels of the selected pixel in parallel.
